(19) United States
(12) Patent Application Publication
(10) Pub. No.: US 2024/0205045 A1
(43) Pub. Date: Jun. 20, 2024

(54) VEHICLE NETWORK SYSTEM AND RESET CONTROL METHOD THEREIN

(71) Applicant: Hyundai AutoEver Corp., Seoul (KR)

(72) Inventors: Sung Jin CHOI, Seoul (KR); Keon Woo LEE, Seoul (KR); Seung Ho LEE, Seoul (KR); Ye Ji PARK, Seoul (KR)

(21) Appl. No.: 18/390,045

(22) Filed: Dec. 20, 2023

(30) Foreign Application Priority Data
Dec. 20, 2022 (KR) 10-2022-0179819

(51) Int. Cl. H04L 12/40

(52) U.S. Cl. CPC H04L 12/40006; H04L 2012/40273

(57) ABSTRACT

A vehicle network system includes a plurality of electronic control units (ECUs) which performs a scheduled task, wherein when an error occurs in any one ECU among the plurality of ECUs, the any one ECU transmits a reset message to the other ECUs, the any one ECU is reset after transmitting the reset message and the other ECUs are reset in response to the reset message so that the plurality of ECUs is sequentially reset according to a task performing order.

### CROSS-REFERENCE TO RELATED APPLICATIONS

This application claims priority to and the benefit of Korean Patent Application No. 10-2022-0179819 filed in the Korean Intellectual Property Office on Dec. 20, 2022, the entire contents of which are incorporated herein by reference.

### TECHNICAL FIELD

The present invention relates to a vehicle network system and a reset control method therein, and more particularly, to a vehicle network system including a plurality of ECUs which performs a scheduled task and a reset control method therein.

### BACKGROUND ART

Recently, in the vehicle, various types of electronic systems are mounted and a plurality of electronic control units (ECU) for controlling the electronic systems have been mounted. The plurality of ECUs is connected to each other through a network of the vehicle and shares the information to perform various functions of the vehicle.

In such a vehicle network system, the plurality of ECUs performs a scheduled task and in particular, when an error occurs in a specific ECU, the task scheduling is agley to cause continuous erroneous operation. In this case, all the ECUs need to be reset to start the scheduled tasks again from the beginning. To this end, in the related art, when the ECU in which an error occurs reports the occurrence of the error to the micro controller unit (MCU), the MCU resets the ECUs which perform the scheduled task.

### SUMMARY OF THE INVENTION

An object to be achieved by the present invention is to provide a vehicle network system which sequentially resets ECUs which perform the scheduled tasks without intervention of the MCU when an error occurs in a specific ECU and a reset control method therein.

The technical object to be achieved by the present invention is not limited to the above-mentioned technical objects, and other technical objects, which are not mentioned above, can be clearly understood by those skilled in the art from the following descriptions.

In order to achieve the above-described technical objects, a vehicle network system according to the present disclosure includes a plurality of electronic control units (ECU) which performs a scheduled task, when an error occurs in any one ECU among the plurality of ECUs, the any one ECU transmits a reset message to the other ECUs, the any one ECU is reset after transmitting the reset message and the other ECUs is reset in response to the reset message so that the plurality of ECUs is sequentially reset according to a task performing order.

The any one ECU transmits the reset message including a reset reference time to the other ECUs and the plurality of ECUs is reset at an added time of the reset reference time and a predetermined time corresponding to the task performing order.

Each of the plurality of ECUs includes a platform health management (PHM) module and a time synchronization (TS) module, when the error occurs in the any one ECU, the TS module transmits the reset message to the other ECUs and in each of the plurality of ECUs, the PHM module resets the ECU at the added time.

Each of the plurality of ECUs further includes a watchdog timer which resets the ECU when a watchdog trigger signal is not received from the PHM module, and in each of the plurality of ECUs, the PHM module resets the ECU at the added time by stopping the transmission of the watchdog trigger signal at the added time.

The PHM module acquires a current time T and sets a timer to t−T+xₖ according to the reset reference time t, the current time T, and the predetermined time xₖ to stop transmission of the watchdog trigger signal after a time t−T+xₖ from the current time T.

The any one ECU transmits a reset message including a reset time corresponding to a task performing order of the corresponding ECU to each of the other ECUs and the plurality of ECUs is reset at a reset time corresponding to the task performing order of the corresponding ECU.

Each of the plurality of ECUs includes a platform health management (PHM) module and a time synchronization (TS) module, when the error occurs in the any one ECU, the TS module transmits the reset message to the other ECUs and in each of the plurality of ECUs, the PHM module resets the ECU at the reset time.

Each of the plurality of ECUs further includes a watchdog timer which resets the ECU when a watchdog trigger signal is not received from the PHM module, and in each of the plurality of ECUs, the PHM module resets the ECU at the reset time by stopping the transmission of the watchdog trigger signal at the reset time.

The PHM module acquires a current time T and sets a timer to tₖ−T according to the reset time tₖ and the current time T to stop transmission of the watchdog trigger signal after a time tₖ−T from the current time T.

In order to achieve the above-described technical objects, a reset control method in a vehicle network system according to the present disclosure which includes a plurality of electronic control units (ECU) which performs a scheduled task, the reset control method includes: a step of transmitting a reset message to the other ECUs by any one ECU when an error occurs in the any one ECU among the plurality of ECUs; and a step of resetting the any one ECU after transmitting the reset message and resetting the other ECUs in response to the reset message so that the plurality of ECUs is sequentially reset according to a task performing order.

In the transmitting step, the any one ECU transmits the reset message including a reset reference time to the other ECUs and in the resetting step, the plurality of ECUs is reset at an added time of the reset reference time and a predetermined time corresponding to the task performing order.

Each of the plurality of ECUs includes a platform health management (PHM) module and a time synchronization (TS) module, in the transmitting step, when the error occurs in the any one ECU, the TS module transmits the reset message to the other ECUs and in the resetting step, the PHM module of each of the plurality of ECUs resets the ECU at the added time.

Each of the plurality of ECUs further includes a watchdog timer which resets the ECU when a watchdog trigger signal is not received from the PHM module, and in the resetting step, the PHM module of each of the plurality of ECUs resets the ECU at the added time by stopping the transmission of the watchdog trigger signal at the added time.

The PHM module acquires a current time T and sets a timer to t−T+xₖ according to the reset reference time t, the current time T, and the predetermined time xₖ to stop transmission of the watchdog trigger signal after a time t−T+xₖ from the current time T.

In the transmitting step, the any one ECU transmits a reset message including a reset time corresponding to a task performing order of the corresponding ECU to each of the other ECUs and in the resetting step, the plurality of ECUs is reset at a reset time corresponding to the task performing order of the corresponding ECU.

Each of the plurality of ECUs includes a platform health management (PHM) module and a time synchronization (TS) module, in the transmitting step, when the error occurs in the any one ECU, the TS module transmits the reset message to the other ECUs and in the resetting step, the PHM module of each of the plurality of ECUs resets the ECU at the reset time.

Each of the plurality of ECUs further includes a watchdog timer which resets the ECU when a watchdog trigger signal is not received from the PHM module, and in each of the plurality of ECUs, the PHM module resets the ECU at the reset time by stopping the transmission of the watchdog trigger signal at the reset time.

The PHM module acquires a current time T and sets a timer to tₖ−T according to the reset time tₖ and the current time T to stop transmission of the watchdog trigger signal after a time tₖ−T from the current time T.

According to the present invention, when an error occurs in a specific ECU in a vehicle network system, ECUs which perform the scheduled tasks are sequentially reset without intervention of the MCU. Accordingly, a configuration of the vehicle network system is simplified and a system efficiency is improved.

Effects of the present disclosure are not limited to the above-mentioned effects, and other effects, which are not mentioned above, can be clearly understood by those skilled in the art from the following descriptions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a configuration of a vehicle network system according to an exemplary embodiment of the present invention.

FIG. 2 illustrates an example that an erroneous operation occurs due to an error occurring in a specific ECU of a vehicle network system.

FIG. 3 illustrates a flowchart of a reset control method according to an exemplary embodiment of the present invention.

FIG. 4 illustrates a flowchart of a reset control method according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the drawings. Substantially same components in the following description and the accompanying drawings may be denoted by the same reference numerals and redundant description will be omitted. Further, in the description of the exemplary embodiment, if it is considered that specific description of related known configuration or function may cloud the gist of the present invention, the detailed description thereof will be omitted.

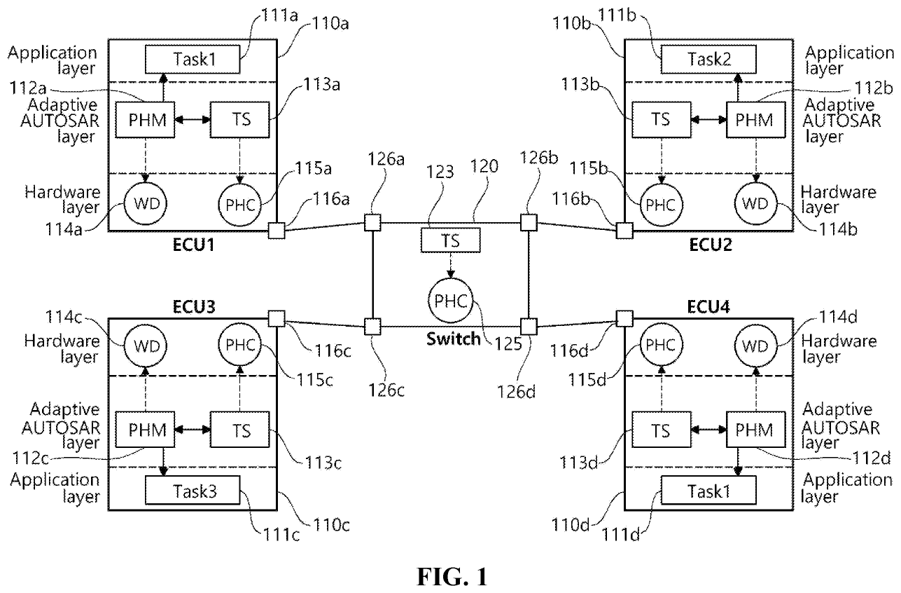

FIG. 1 illustrates a configuration of a vehicle network system according to an exemplary embodiment of the present invention.

Referring to FIG. 1, a vehicle network system according to the exemplary embodiment includes first to fourth ECUs 110a, 110b, 110c, and 110d and an Ethernet switch 120. In the present exemplary embodiment, for the convenience of description, four ECUs will be described, but the number of ECUs may be an arbitrary number of 2 or larger. Hereinafter, an ECU 100 may refer to an arbitrary ECU among first to fourth ECUs 110a, 110b, 110c, and 110d.

The first to fourth ECUs 110a, 110b, 110c, and 110d each have an application layer, adaptive AUTOSAR layer, and a hardware layer.

In the application layers of the first to fourth ECUs 110a, 110b, 110c, and 110d, first to fourth tasks 111a, 111b, 111c, and 111d may be performed by each application. The first to fourth tasks 111a, 111b, 111c, and 111d are scheduled to be operated.

The first to fourth ECUs 110a, 110b, 110c, and 11d include a platform health management (PHM) module 112a, 112b, 112c, 112d and time synchronization (TS) modules 113a, 113b, 113c, and 113d, respectively, in the adaptive AUTOSAR layer and include watchdog modules 114a, 114b, 114c, and 114d, a PTP hardware clock (PHC) modules 115a, 115b, 115c, and 115d, and Ethernet ports 116a, 116b, 116c, and 116d in the hardware layer.

The Ethernet switch 120 includes a TS module 123, a PHC module 125, and Ethernet ports 126a, 126b, 126c, and 126d.

In the following description, the PHM module 112 may refer to an arbitrary PHM module among the PHM modules 112a, 112b, 112c, and 112d. Further, the TS module 113 may refer to an arbitrary TS module among the TS modules 113a, 113b, 113c, and 113d. Further, the watchdog module 114 may refer to an arbitrary watchdog module among the watchdog modules 114a, 114b, 114c, and 114d. Further, the PHC module 115 may refer to an arbitrary PHC module among the PHC modules 115a, 115b, 115c, and 115d. Further, the Ethernet port 116 may refer to an arbitrary Ethernet port among the Ethernet ports 116a, 116b, 116c, and 116d.

The ECU 100 may transmit and receive data with the other ECUs through the Ethernet port 116 and the Ethernet switch 120.

The PHM module 112 is a module provided from the adaptive AUTOSAR and performs a function of supervising a health status of an application. The PHM module 112 transmits a watchdog trigger signal to the watchdog module 114 in a normal status and resets the node by stopping the transmission of the watchdog trigger signal.

The TS module 113 is a module provided from the adaptive AUTOSAR and synchronizes PHC modules in the nodes in the network by transmitting and receiving a gPTP (network-time synchronization protocol) packet to allow all the nodes in the network to use the same time zone. Alternatively, the TS module 113 divides the network for every domain to use different time zones for every domain.

The watchdog module 114 senses a watchdog trigger signal received from the PHM module 112 and resets the corresponding node when the watchdog trigger signal is not received.

The PHC module 115 performs a function of synchronizing a time in the network.

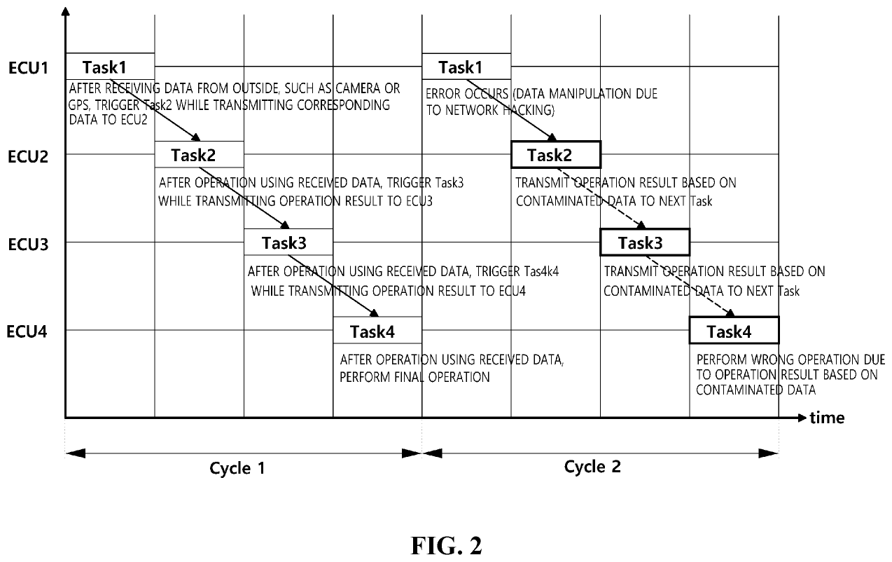

FIG. 2 illustrates an example that an erroneous operation occurs due to an error occurring in a specific ECU of a vehicle network system.

Referring to FIG. 2, a first task 111a of the first ECU 110a receives data from the outside, such as a camera or a GPS and then triggers the second task 111b of the second ECU 110b while transmitting the corresponding data to the second ECU 110b. A second task 111b of the second ECU 110b operates using the received data and then triggers the third task 111c of the third ECU 110c while transmitting the operation result to the third ECU 110c. A third task 111c of the third ECU 110c operates using the received data and then triggers the fourth task 111d of the fourth ECU 110d while transmitting the operation result to the fourth ECU 110d. The fourth task 111d of the fourth ECU 110d operates using the received data and then performs a final operation.

As described above, when the first to fourth tasks 111a, 111b, 111c, and 111d are scheduled to each other to operate, if an error occurs in the second task 111b of the second ECU 110b, the second task 111b of the second ECU 110b transmits an operation result based on contaminated data to the third ECU 110c. By doing this, the third task 111c of the third ECU 110c also transmits an operation result based on the contaminated data to the fourth ECU 110d so that the fourth task 111d of the fourth ECU 110d may perform an erroneous operation due to the operation result based on the contaminated data.

That is, when all the tasks normally operate in one cycle, the corresponding function normally operates and when an error occurs in any one ECU so that the data is contaminated, the data contamination is accumulated in accordance with the task which is scheduled to be sequentially triggered. Accordingly, when an error occurs in any one ECU, all the ECUs need to be sequentially reset according to a task performing order and collects data again from the beginning to perform the operation.

In the exemplary embodiments of the present invention, a new function API is added to the PHM module 112 and the TS module 113 to control all the ECUs which perform the scheduled task in the vehicle network system to be sequentially reset according to a task performing order.

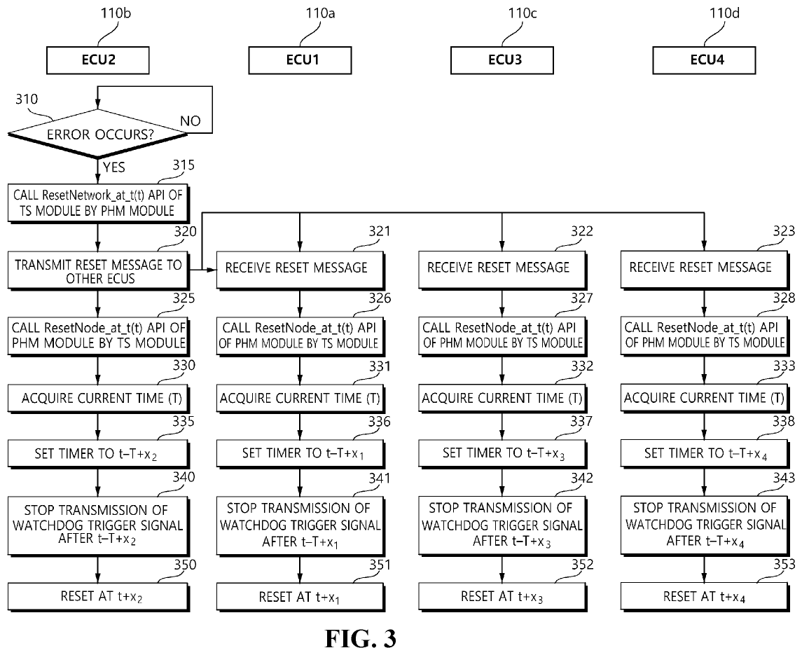

FIG. 3 illustrates a flowchart of a reset control method according to an exemplary embodiment of the present invention. In the exemplary embodiment of the present invention, in the TS module 113, a ResetNetwork_at_t API which is a function of transmitting a reset message indicating all the nodes of the network to perform the reset after a reset reference time t is added. Further, in the PHM module 112, ResetNode_at_t API which is a function of performing the reset of the node by stopping transmission of the watchdog trigger signal to the watchdog module 114 at an added time (t+xₖ) of a reset reference time t and a predetermined time xₖ (here, k indicates an order of performing a task) corresponding to the order of performing the task is added. A xₖ value of the k-th task is a value determining how many seconds it is reset based on the reset reference time t and is set in advance in the PHM module 112 in accordance with the order of performing the task of the task supervised by the PHM module 112. For example, when the order of performing the task is the first task 111a→the second task 111b→the third task 111c→the fourth task 111d, the value xₖ of each PHM module 112 is set as x₁<x₂<x₃<x₄.

In step 310, the PHM module 112b of the second ECU 110b senses that an error occurs in the second task 111b.

In step 315, the PHM module 112b calls ResetNetwork_at_t(t) API of the TS module 113b. Here, t indicates a reset reference time to allow all the ECUs 110a, 110b, 110c, and 110d to perform reset after the corresponding time.

In step 320, the TS module 113b transmits a reset message including the reset reference time t to the other ECUs 110a, 110c, and 110d belonging to the vehicle network system. Here, the reset message is transmitted in a broadcasting manner.

In step 325, the TS module 113b calls ResetNode_at_t(t) API of the PHM module 112b.

In step 330, the PHM module 112b obtains a current time T of the PHC module 115b using a now( ) API provided by the TS module 113b.

In step 335, the PHM module 112b sets a timer to t−T+x₂ using StartTimer API provided by the TS module 113b.

In step 340, the PHM module 112b stops the transmission of the watchdog trigger signal to the watchdog module 114b after a time t−T+x₂ from the current time T.

When the watchdog trigger signal is not received by stopping the transmission of the watchdog trigger signal, in step 350, the watchdog module 114b resets the second ECU 110b so that the second ECU 110b is reset at a time t+x₂.

In the meantime, as the reset message is transmitted in step 320, in step 321, the first ECU 110a receives the reset message from the second ECU 110b.

In step 326, the TS module 113a calls ResetNode_at_t(t) API of the PHM module 112a.

In step 331, the PHM module 112a obtains a current time T of the PHC module 115a using a now( ) API provided by the TS module 113a.

In step 336, the PHM module 112a sets a timer to t−T+x₁ using StartTimer API provided by the TS module 113a.

In step 341, the PHM module 112a stops the transmission of the watchdog trigger signal to the watchdog module 114a after a time t−T+x₁ from the current time T.

When the watchdog trigger signal is not received by stopping the transmission of the watchdog trigger signal, in step 351, the watchdog module 114a resets the first ECU 110a so that the first ECU 110a is reset at a time t+x₁.

In the meantime, as the reset message is transmitted in step 320, in step 322, the third ECU 110c receives the reset message from the second ECU 110b.

In step 327, the TS module 113c calls ResetNode_at_t(t) API of the PHM module 112c.

In step 332, the PHM module 112c obtains a current time T of the PHC module 115c using a now( ) API provided by the TS module 113c.

In step 337, the PHM module 112c sets a timer to t−T+x₃ using StartTimer API provided by the TS module 113c.

In step 342, the PHM module 112c stops the transmission of the watchdog trigger signal to the watchdog module 114c after a time t−T+x₃ from the current time T.

When the watchdog trigger signal is not received by stopping the transmission of the watchdog trigger signal, in step 352, the watchdog module 114c resets the third ECU 110c so that the third ECU 110c is reset at a time t+x₃.

In the meantime, as the reset message is transmitted in step 320, in step 323, the fourth ECU 110d receives the reset message from the second ECU 110b.

In step 328, the TS module 113d calls ResetNode_at_t(t) API of the PHM module 112d.

In step 333, the PHM module 112d obtains a current time T of the PHC module 115d using a now( ) API provided by the TS module 113d.

In step 338, the PHM module 112d sets a timer to t−T+x₄ using StartTimer API provided by the TS module 113d.

In step 343, the PHM module 112d stops the transmission of the watchdog trigger signal to the watchdog module 114d after a time t−T+x₄ from the current time T.

When the watchdog trigger signal is not received by stopping the transmission of the watchdog trigger signal, in step 353, the watchdog module 114d resets the fourth ECU 110d so that the fourth ECU 110d is reset at a time t+x₄.

By means of the steps 351, 350, 352, and 353, the first ECU 110a is reset at the time t+x₁, the second ECU 110b is reset at the time t+x₂, the third ECU 110c is reset at the time t+x₃, and the fourth ECU 110d is reset at the time t+x₄, so that the first to fourth ECUs 110a, 110b, 110c, and 110d are sequentially reset.

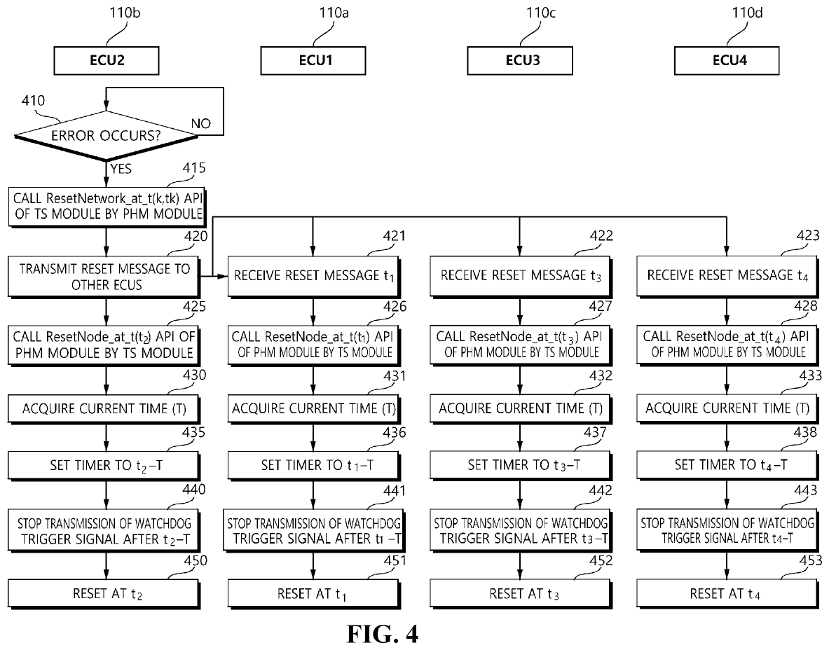

FIG. 4 illustrates a flowchart of a reset control method according to another exemplary embodiment of the present invention.

In an exemplary embodiment of the present disclosure, in the TS module 113, ResetNetwork_at_t API which is a function of transmitting a reset message indicating to perform the reset after a reset time tₖ for every node to each node of the network is added. Further, in the PHM module 112, ResetNode_at_t API which is a function of resetting the corresponding node by stopping transmission of the watchdog trigger signal to the watchdog module 114 at the reset time tₖ of the corresponding node is added. The reset time tₖ for every node is set in advance to the PHM module 112 in accordance with the task performing order of each node or variably determined by the PHM module 112. For example, when the task performing order is the first task 111a→the second task 111b→the third task 111c→the fourth task 111d, the value xₖ of each PHM module 112 is determined as t₁<t₂<t₃<t₄.

In step 410, the PHM module 112b of the second ECU 110b senses that an error occurs in the second task 111b.

In step 415, the PHM module 112b calls ResetNetwork_at_t(k, tₖ) API of the TS module 113b. Here, k indicates an ECU (or a task) and tₖ indicates a reset time corresponding to the task performing order of a k-th ECU.

In step 420, the TS module 113b transmits a reset message including the reset time corresponding to the task performing order of the corresponding ECU to the other ECUs 110a, 110c, and 110d belonging to the vehicle network system. For example, the TS module 113b transmits a reset message including t₁ to the first ECU 110a, transmits a reset message including t₃ to the third ECU 110c, and transmits a reset message including t₄ to the fourth ECU 110d. Here, the reset message is transmitted in a uni-casting manner.

In step 425, the TS module 113b calls ResetNodek_at_t(t₂) API of the PHM module 112b.

In step 430, the PHM module 112b obtains a current time T of the PHC module 115b using a now( ) API provided by the TS module 113b.

In step 435, the PHM module 112b sets a timer to t₂−T using StartTimer API provided by the TS module 113b.

In step 440, the PHM module 112b stops the transmission of the watchdog trigger signal to the watchdog module 114b after a time t₂−T from the current time T.

When the watchdog trigger signal is not received by stopping the transmission of the watchdog trigger signal, in step 450, the watchdog module 114b resets the second ECU 110b so that the second ECU 110b is reset at a time t₂.

In the meantime, as the reset message including ti is transmitted in step 420, in step 421, the first ECU 110a receives the reset message including ti from the second ECU 110b.

In step 426, the TS module 113a calls ResetNode_at_t(t₁) API of the PHM module 112a.

In step 431, the PHM module 112a obtains a current time T of the PHC module 115a using a now( ) API provided by the TS module 113a.

In step 436, the PHM module 112a sets a timer to t₁−T using StartTimer API provided by the TS module 113a.

In step 441, the PHM module 112a stops the transmission of the watchdog trigger signal to the watchdog module 114a after a time t₁−T from the current time T.

When the watchdog trigger signal is not received by stopping the transmission of the watchdog trigger signal, in step 451, the watchdog module 114a resets the first ECU 110a so that the first ECU 110a is reset at a time t₁.

In the meantime, as the reset message including t₃ is transmitted in step 420, in step 422, the third ECU 110c receives the reset message including t₃ from the second ECU 110b.

In step 427, the TS module 113c calls ResetNode_at_t(t₃) API of the PHM module 112c.

In step 432, the PHM module 112c obtains a current time T of the PHC module 115c using a now( ) API provided by the TS module 113c.

In step 437, the PHM module 112c sets a timer to t₃−T using StartTimer API provided by the TS module 113c.

In step 442, the PHM module 112c stops the transmission of the watchdog trigger signal to the watchdog module 114c after a time t₃−T from the current time T.

When the watchdog trigger signal is not received by stopping the transmission of the watchdog trigger signal, in step 452, the watchdog module 114c resets the third ECU 110c so that the third ECU 110c is reset at a time t₃.

In the meantime, as the reset message including t₄ is transmitted in step 420, in step 423, the fourth ECU 110d receives the reset message including t₄ from the second ECU 110b.

In step 428, the TS module 113d calls ResetNode_at_t(t₄) API of the PHM module 112d.

In step 433, the PHM module 112d obtains a current time T of the PHC module 115d using a now( ) API provided by the TS module 113d.

In step 438, the PHM module 112d sets a timer to t₄−T using StartTimer API provided by the TS module 113d.

In step 443, the PHM module 112d stops the transmission of the watchdog trigger signal to the watchdog module 114d after a time t₄−T from the current time T.

When the watchdog trigger signal is not received by stopping the transmission of the watchdog trigger signal, in step 454, the watchdog module 114d resets the fourth ECU 110d so that the fourth ECU 110d is reset at a time t₄.

By means of the steps 451, 450, 452 and 453, the first ECU 110a is reset at the time t₁, the second ECU 110b is reset at the time t₂, the third ECU 110c is reset at the time t₃, and the fourth ECU 110d is reset at the time t₄, so that the first to fourth ECUs 110a, 110b, 110c, and 110d are sequentially reset.

The combinations of blocks of the block diagrams and steps in the flowcharts of the present invention may be implemented by computer program instructions. The computer program instructions may be loaded in a processor of a general purpose computer, a special purpose computer, or other programmable data processing apparatus, so that the instructions executed via the processor of the computer or other programmable data processing apparatus create means for implementing the functions described in the blocks of the block diagrams or the steps in the flowcharts. These computer program instructions may also be stored in a computer-usable or computer readable memory that may direct a computer or other programmable data processing apparatus to implement function in a particular manner, so that the instructions stored in the computer usable or computer readable memory produce a manufacturing article including instruction means which implement the function indicated in the blocks of the block diagrams or the steps in the flowcharts. The computer program instructions may be loaded onto a computer or other programmable data processing apparatus to cause a series of operational steps to be performed on the computer or other programmable data processing apparatus to produce a computer implemented process such that the instructions executed on the computer or other programmable data processing apparatus provide steps for implementing the functions described in the blocks of the block diagrams or the steps in the flowcharts.

Each block or each step may represent a part of a module, a segment or a code, including one or more executable instructions for executing specific logical function(s). In addition, it should be noted that the functions mentioned in the blocks or steps may occur out of order in several alternative embodiments. For example, two blocks or steps shown in succession may be executed substantially concurrently, or blocks or steps sometimes may be executed in reverse order according to corresponding functions.

It will be appreciated that various exemplary embodiments of the present invention have been described herein for purposes of illustration, and that various modifications, changes, and substitutions may be made by those skilled in the art without departing from the scope and spirit of the present invention. Therefore, the exemplary embodiments of the present disclosure are provided for illustrative purposes only but not intended to limit the technical concept of the present disclosure. The scope of the technical concept of the present disclosure is not limited thereto. The protection scope of the present invention should be interpreted based on the following appended claims and it should be appreciated that all technical spirits included within a range equivalent thereto are included in the protection scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A vehicle network system comprising:
a plurality of electronic control units (ECUs) configured to perform a scheduled task,
wherein when an error occurs in at least one ECU among the plurality of ECUs, the at least one ECU transmits a reset message to remaining ECUs, the at least one ECU is reset after transmitting the reset message and the remaining ECUs are reset in response to the reset message, and the plurality of ECUs is sequentially reset according to a task performing order.

2. The vehicle network system according to claim 1, wherein the at least one ECU transmits the reset message including a reset reference time to the remaining ECUs, and each of the plurality of ECUs is reset at an added time of the reset reference time and a predetermined time corresponding to the task performing order.

3. The vehicle network system according to claim 2, wherein each of the plurality of ECUs includes a platform health management (PHM) module and a time synchronization (TS) module, and wherein when the error occurs in the at least one ECU, the TS module transmits the reset message to the remaining ECUs, and in each of the plurality of ECUs, the PHM module resets the ECU at the added time.

4. The vehicle network system according to claim 3, wherein each of the plurality of ECUs further includes a watchdog timer which resets the ECU when a watchdog trigger signal is not received from the PHM module, and in each of the plurality of ECUs, the PHM module resets the ECU at the added time by stopping transmission of the watchdog trigger signal at the added time.

5. The vehicle network system according to claim 4, wherein the PHM module acquires a current time T and sets a timer to t−T+xₖ according to the reset reference time t, the current time T, and the predetermined time xₖ to stop transmission of the watchdog trigger signal after a time t−T+xₖ from the current time T.

6. The vehicle network system according to claim 1, wherein the at least one ECU transmits a reset message including a reset time corresponding to a task performing order of a corresponding ECU to each of the remaining ECUs and the plurality of ECUs is reset at a reset time corresponding to the task performing order of the corresponding ECU.

7. The vehicle network system according to claim 6, wherein each of the plurality of ECUs includes a platform health management (PHM) module and a time synchronization (TS) module, and wherein when the error occurs in the at least one ECU, the TS module transmits the reset message to the remaining ECUs, and in each of the plurality of ECUs, the PHM module resets the ECU at the reset time.

8. The vehicle network system according to claim 7, wherein each of the plurality of ECUs further includes a watchdog timer which resets the ECU when a watchdog trigger signal is not received from the PHM module, and in each of the plurality of ECUs, the PHM module resets the ECU at the reset time by stopping transmission of the watchdog trigger signal at the reset time.

9. The vehicle network system according to claim 8, wherein the PHM module acquires a current time T and sets a timer to tₖ−T according to the reset time tₖ and the current time T to stop transmission of the watchdog trigger signal after a time tₖ−T from the current time T.

10. A reset control method in a vehicle network system which includes a plurality of electronic control units (ECUs) configured to perform a scheduled task, the reset control method comprising:
transmitting, by at least one ECU, a reset message to remaining ECUs when an error occurs in the at least one ECU among the plurality of ECUs; and
resetting the at least one ECU after transmitting the reset message and resetting the remaining ECUs in response to the reset message to ensure that the plurality of ECUs is sequentially reset according to a task performing order.

11. The reset control method according to claim 10, wherein in transmitting, the at least one ECU transmits the reset message including a reset reference time to the remaining ECUs, and in resetting, the plurality of ECUs is reset at an added time of the reset reference time and a predetermined time corresponding to the task performing order.

12. The reset control method according to claim 11, wherein each of the plurality of ECUs includes a platform health management (PHM) module and a time synchronization (TS) module, and wherein in transmitting, when the error occurs in the at least one ECU, the TS module transmits the reset message to the remaining ECUs, and in resetting, the PHM module of each of the plurality of ECUs resets the ECU at the added time.

13. The reset control method according to claim 12, wherein each of the plurality of ECUs further includes a watchdog timer which resets the ECU when a watchdog trigger signal is not received from the PHM module, and in resetting, the PHM module of each of the plurality of ECUs resets the ECU at the added time by stopping transmission of the watchdog trigger signal at the added time.

14. The reset control method according to claim 13, wherein the PHM module acquires a current time T and sets a timer to t−T+xₖ according to the reset reference time t, the current time T, and the predetermined time xₖ to stop transmission of the watchdog trigger signal after a time t−T+xₖ from the current time T.

15. The reset control method according to claim 10, wherein in transmitting, the at least one ECU transmits a reset message including a reset time corresponding to a task performing order of a corresponding ECU to each of the remaining ECUs, and in resetting, the plurality of ECUs is reset at a reset time corresponding to the task performing order of the corresponding ECU.

16. The reset control method according to claim 15, wherein each of the plurality of ECUs includes a platform health management (PHM) module and a time synchronization (TS) module, and wherein in transmitting, when the error occurs in the at least one ECU, the TS module transmits the reset message to the remaining ECUs, and in resetting, the PHM module of each of the plurality of ECUs resets the ECU at the reset time.

17. The reset control method according to claim 16, wherein each of the plurality of ECUs further includes a watchdog timer which resets the ECU when a watchdog trigger signal is not received from the PHM module, and in each of the plurality of ECUs, the PHM module resets the ECU at the reset time by stopping transmission of the watchdog trigger signal at the reset time.

18. The reset control method according to claim 17, wherein the PHM module acquires a current time T and sets a timer to tₖ−T according to the reset time tₖ and the current time T to stop transmission of the watchdog trigger signal after a time t₁−T from the current time T.
